(19) United States
(12) Patent Application Publication
(10) Pub. No.: US 2007/0209627 A1
(43) Pub. Date: Sep. 13, 2007

(54) Cylinder Sleeve For An Internal Combustion Engine

(76) Inventors: Karlheinz Bing, Remseck (DE); Stefan Spangenberg, Korntal-Munchingen (DE); Georg Schuller, Frankenmarkt (AT)

Correspondence Address: WILLIAM COLLARD;COLLARD & ROE, P.C., 1077 NORTHERN BOULEVARD, ROSLYN, NY, 11576, US

(21) Appl. No.: 10/589,792

(22) PCT Filed: Feb. 18, 2005
(86) PCT No.: PCT/DE05/00283

§ 371 Date: Oct. 5, 2006

(30) Foreign Application Priority Data
Feb. 18, 2004 (DE) 10 2004 007 774.6

(51) Int. Cl. F02F 1/00

(52) U.S. Cl. 123/193.2

(57) ABSTRACT

Disclosed is a cylinder sleeve for an internal combustion engine. The outer surface of said cylinder sleeve is provided with a flat zone (61) that extends along the entire axial length thereof. The inventive cylinder sleeve is embodied as a rough cast sleeve whose outer surface comprises a rough zone that extends along the entire axial length thereof and consists of a plurality of elevations with undercuts in order to ensure that a sufficient amount of combustion heat generated during operation of the engine is discharged.

The invention relates to a cylinder sleeve for an internal combustion engine, according to the preamble of claim 1.

A cylinder sleeve in accordance with the preamble of the main claim, made of iron, is known from the European patent document EP 0 837 235 B1, which sleeve is cast into an engine block made of aluminum, by way of its lower region, and has engagement segments that run over the circumference of the sleeve, in this region, which segments are vise-shaped in cross-section, and serve to anchor the sleeve in the material of the engine block. In this way, a gap is prevented from forming between the cylinder sleeve and the engine block as the cylinder sleeve and the engine block warm up, due to the different expansion coefficients of iron and aluminum, which gap can result in deterioration of the heat elimination by way of the engine block, in overheating of the cylinder sleeve, and thereby in damage to the latter.

However, in this connection, only the lower sleeve region, which is subject to relatively less stress, in terms of temperature, is cast into the engine block. The upper region of the cylinder sleeve is subject to much greater stress, in terms of temperature, since combustion takes place here, and since the cylinder sleeves are disposed very closely next to one another, because of their laterally flattened regions. For this reason, according to the state of the art, this region is surrounded by a gap into which water is introduced to cool this region of the cylinder sleeve. This results in a very complicated design, which furthermore offers little strength for the upper region of the cylinder sleeve, on which the forces that result from the ignition pressure of the combustion that takes place here act, and which is surrounded exclusively by a water mantle.

It is therefore the task of the invention to create a cylinder sleeve having a laterally flattened region, which sleeve can be disposed so as to save space, and is configured in such a manner that it nevertheless can be completely cast into an engine block, without temperature problems occurring during engine operation, due to lack of heat elimination.

This task is accomplished with the characteristics standing in the characterizing part of the main claim. Practical embodiments of the invention are the object of the dependent claims.

In this connection, the roughened region on the outer surface of the rough-cast sleeve offers a very large outer surface standing in contact with the material of the engine block, by way of which the combustion heat can be conducted away well. Furthermore, the plurality of elevations with undercuts results in tight clamping between sleeve and engine block, which prevents the formation of a thermally insulating gap between sleeve and engine block in the case of different expansion coefficients due to different materials of sleeve and engine block.

Some exemplary embodiments of the invention will be described in the following, using the drawings. These show:

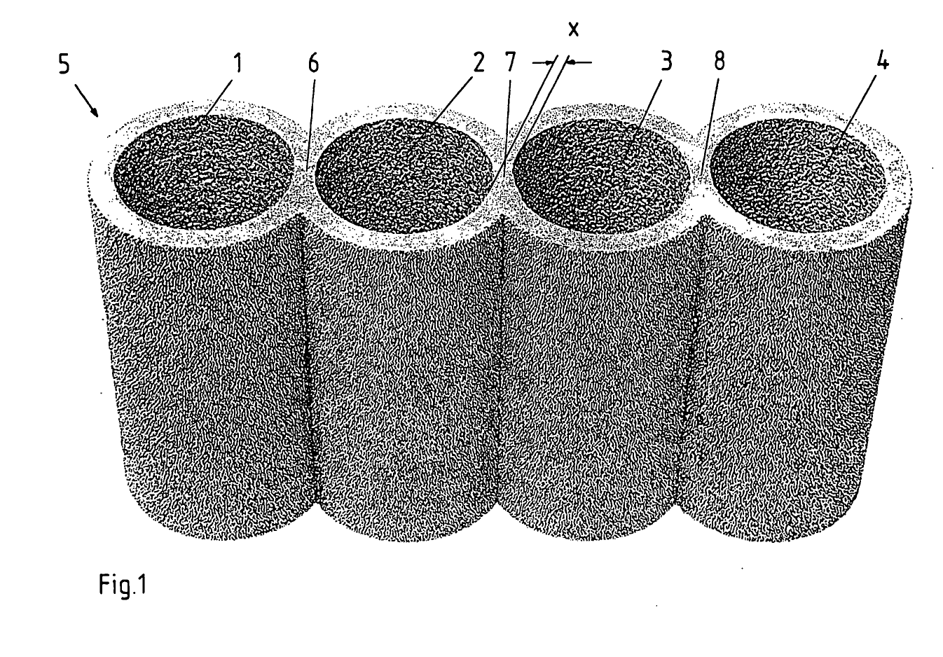

FIG. 1 a sleeve package consisting of 4 rough-cast sleeves, for use in a four-cylinder engine,

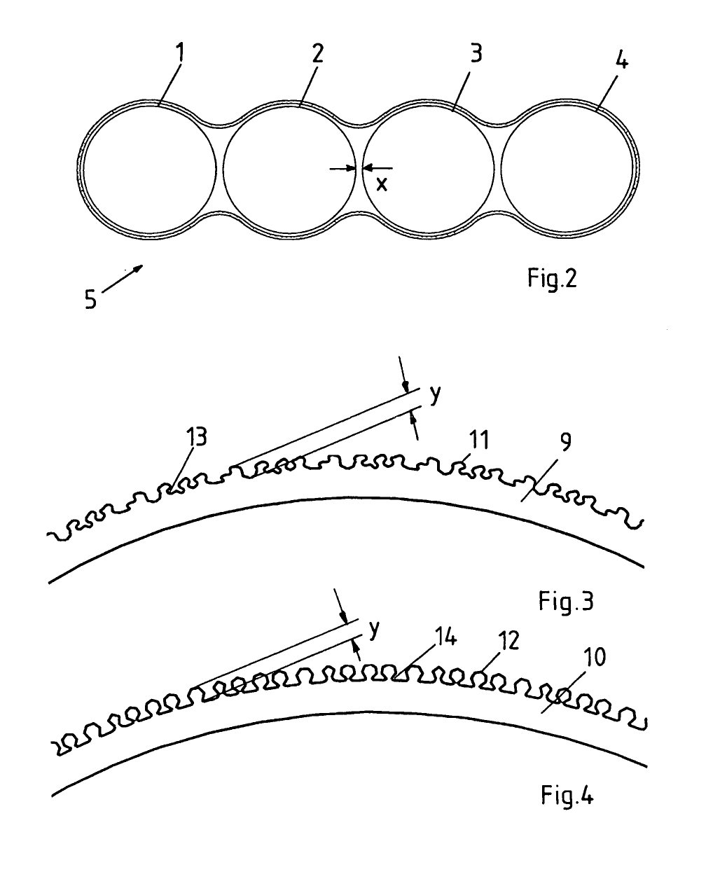

FIG. 2 the rough-cast sleeve package according to FIG. 1 in a top view,

FIGS. 3, 4 enlarged cross-sections through parts of the sleeve wall, with configuration possibilities of its surface roughness,

FIG. 5-7 configurations of flattened rough-cast sleeves with a variable sleeve wall thickness and constant depth of the roughened region,

FIG. 8 an arrangement of 4 rough-cast sleeves having an elliptical outside contour, according to FIG. 5, for use in a four-cylinder engine,

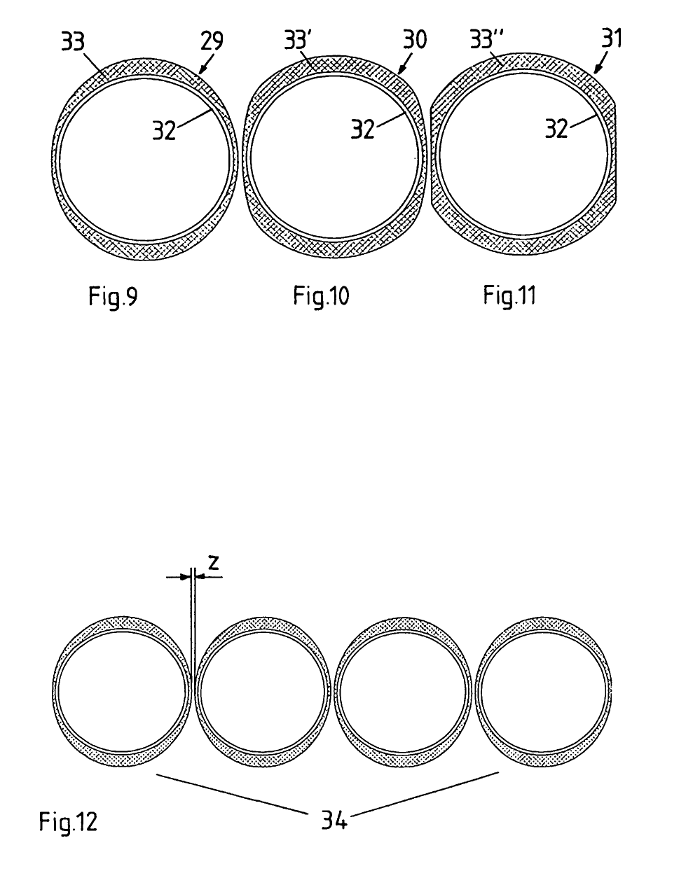

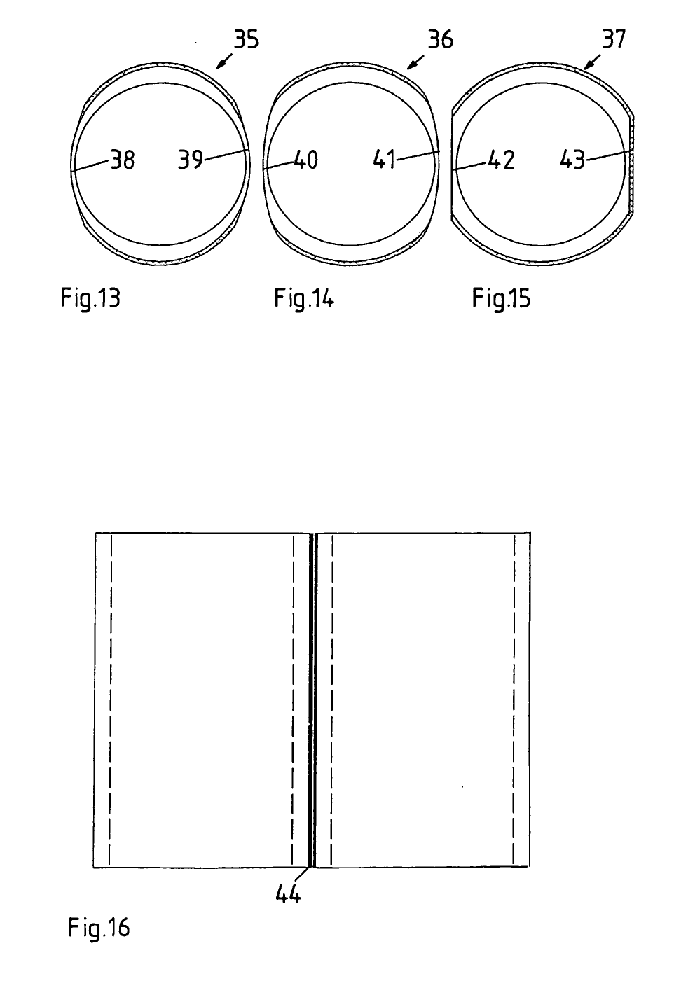

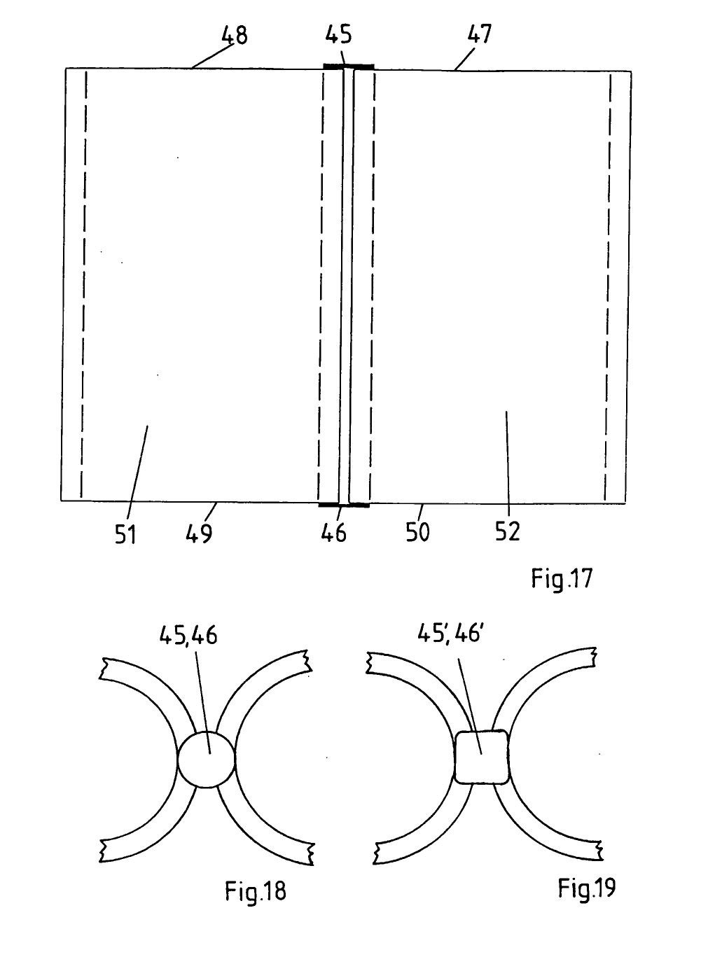

FIG. 9-11 configurations of flattened rough-cast sleeves having a constant sleeve wall thickness and variable depth of the roughened region,

FIG. 12 an arrangement of 4 rough-cast sleeves having an elliptical outside contour, according to FIG. 9, for use in a four-cylinder engine,

FIG. 13-15 configurations of flattened rough-cast sleeves having a variable sleeve wall thickness, constant depth of the roughened region, and without rough-cast structures on the outer surfaces of those sleeve regions that lie opposite one another in the case of the rough-cast sleeves combined to form sleeve packages, and are flattened,

FIG. 16 two rough-cast sleeves joined together by way of their flattened regions,

FIG. 17 two rough-cast sleeves joined together using two bridges,

FIG. 18 a configuration of a bridge for joining rough-cast sleeves,

FIG. 19 another configuration of a bridge for joining rough-cast sleeves,

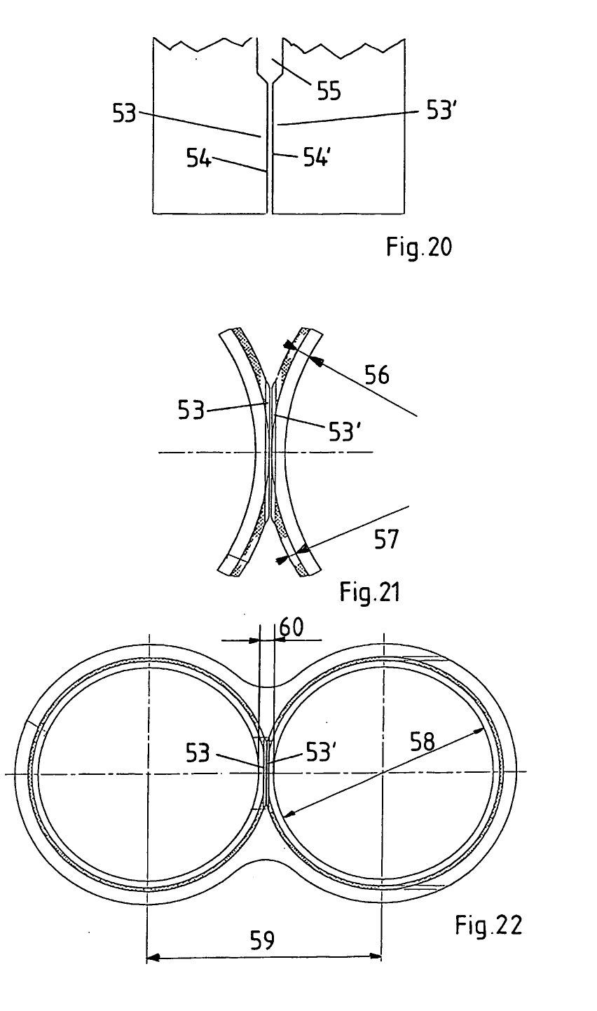

FIG. 20-24 rough-cast sleeves having one flattened region each, which has a step in its lower region,

FIG. 25 two rough-cast sleeves joined together, having a spacer between the flattened regions,

FIG. 26 an enlarged representation of the spacer according to FIG. 25.

FIG. 1 shows, in a perspective view, and FIG. 2 shows, in a top view, a sleeve package 5 consisting of four rough-cast sleeves 1 to 4. The 4 rough-cast sleeves 1 to 4 have roughened outer surfaces over their entire axial length. In this connection, the common wall regions 6 to 8 of adjacent sleeves 1 to 4 have a land width x that corresponds to the other wall thickness of the rough-cast sleeves 1 to 4.

The entire sleeve package 5 is produced in a single casting process, from an aluminum-silicon alloy, whereby the gravity casting method or the “lost-foam” casting method is used. Both of these casting methods are known from the state of the art (see DE 199 58 185 A1 with regard to the “lost-foam” casting method), and will not be explained in greater detail here. In the production of an engine block, the entire sleeve package 5 is set into the casting mold provided for this purpose, and casting material is cast around it.

The cross-sections 9 and 10 through parts of the wall of the rough-cast sleeves, shown in FIGS. 3 and 4, show configurations of the roughened region, whereby the roughened region according to cross-section 9 has elevations 11 distributed in irregular manner, and the roughened region according to cross-section 10 has elevations 12 distributed in regular manner. In both cases, the elevations 10 and 11 are shaped in such a manner that undercuts 13 and 14 are formed by them, the function of which consists in anchoring the rough-cast sleeves in the casting material of the engine block. The height of the elevations 11 and 12 and thereby the depth y of the roughened region have a value of 0.2 to 2 mm.

The flattened rough-cast sleeves shown in cross-section in FIGS. 5 to 15 can consist of cast iron and are then preferably produced using the spin casting method. However, they can also consist of an aluminum-silicon alloy, which opens up the possibility of producing the rough-cast sleeves using the gravity casting method, the spin casting method, or the “lost-foam” casting method. Finally, there is the possibility of producing the rough-cast sleeves from a sintered metal. In this connection, the sleeves can already obtain their final shape, flattened on one or two sides, within the framework of the casting process. However, there is also the possibility of flattening the sleeves after casting, by means of mechanical machining (milling).

In the production of an engine block from light metal, such as, for example, from aluminum, magnesium, or an alloy of these metals, there is the possibility, for one thing, of setting the sleeves onto spindle sleeves of the casting mold, orienting them in such a manner that that the flattened regions of the sleeves lie against one another, and then casting the light metal of the engine block around them. For another thing, the sleeves can be joined to one another by way of their flattened regions, i.e. welded, soldered, or glued to one another by way of the flattened mantle surfaces, so that eyeglass-shaped arrangements of the sleeves result, in cross-section. The sleeve packages obtained in this manner are then laid into the casting mold and the light metal of the engine block is cast around them.

The following configuration possibilities of rough-cast sleeves, shown in FIGS. 5 to 7, 9 to 11, and 13 to 15, are possible: FIG. 5: A sleeve 15 having an elliptical outer shape in cross-section, variable thickness of the sleeve wall 19, and constant depth of the roughened region 20 is shown.

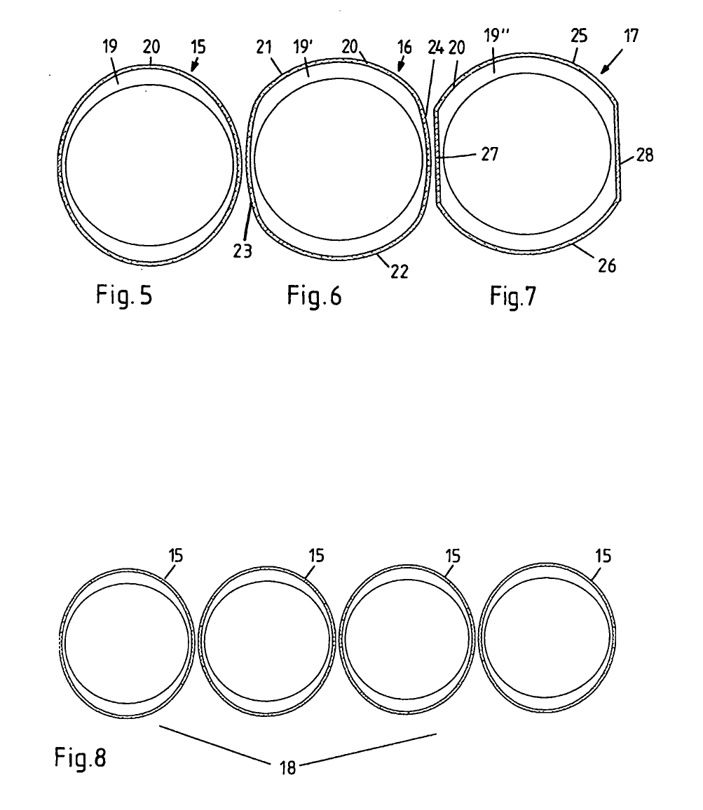

FIG. 6: A sleeve 16 having a variable thickness of the sleeve wall 19′, with a constant depth of the roughened region 20, and an outer shape that consists of four arc-shaped segments 21 to 24 of approximately equal size, whereby thicker regions of the sleeve wall 19′ delimit the segments 21 and 22 that lie opposite one another, and thinner regions of the sleeve wall 19′, i.e. its flattened regions, delimit the segments 23 and 24 that lie opposite one another, towards the outside, is shown.

FIG. 7: A sleeve 17 having a variable thickness of the sleeve wall 19″, with a constant depth of the roughened region 20 and an outer shape that is composed, in cross-section, of two arc-shaped segments 25 and 26 that lie opposite one another, and two flat segments 27 and 28 that like opposite one another, is shown. In this connection, the flattened regions of the sleeve 17 that lie opposite one another are delimited, towards the outside, by the segments 27 and 28.

FIG. 8 shows a possibility of disposing the rough-cast sleeves 15 having an elliptical contour next to one another, in space-saving manner, so that a sleeve package 18 that is suitable for a four-cylinder engine is obtained. In this connection, the regions of the elliptical contour next to the axis delimit the flattened regions of the sleeves 15, which flattened regions lie at a distance opposite one another in the arrangement of the sleeves 15 to form a sleeve package 18.

FIG. 9: A sleeve 29 having a constant thickness of the sleeve wall 32, with a variable depth of the roughened region 33 and with an elliptical outer contour in cross-section, which is the same as the outer shape of the sleeve 15 according to FIG. 5, is shown.

FIG. 10: A sleeve 30 having a constant thickness of the sleeve wall 32, with a variable depth of the roughened region 33′, and with an outer contour consisting of two arc-shaped segments, in cross-section, which contour is the same as the outer shape of the sleeve 16 according to FIG. 6, is shown.

FIG. 11: A sleeve 31 having a constant thickness of the sleeve wall 32, with a variable depth of the roughened region 33″, and an outer contour formed from two arc-shaped segments and two flat segments, which lie opposite one another, in each instance, which contour is the same as the outer shape of the sleeve 17 shown in FIG. 7, is shown.

The rough-cast sleeves 29 to 31 shown in FIG. 9 to 11 are produced using the spin casting method, whereby the variation of the depth of the roughened regions 33, 33′, and 33″ can be achieved by means of a corresponding adjustment of the process parameters.

FIG. 12 shows an arrangement of 4 of the rough-cast sleeves 29 shown in FIG. 9 to form a sleeve package 34 similar to the sleeve package 18 shown in FIG. 8, for use in a four-cylinder engine. In this connection, the rough-cast sleeves of the type shown can be disposed at a distance z of 0.5 to 0.05 mm next to one another.

FIG. 13: A sleeve 35 having a variable sleeve wall thickness, constant depth of the roughened region, and an elliptical outer contour, which is the same as the outer contour of the sleeve 15 shown in FIG. 5, is shown. In this connection, the flattened sleeve regions 38 and 39 that lie opposite one another do not have any rough-cast structures.

FIG. 14: A sleeve 36 having a variable sleeve wall thickness, constant depth of the roughened region, and an outer contour consisting of several arc-shaped segments, in cross-section, which contour is the same as the outer shape of the sleeve 16 shown in FIG. 6, is shown. The flattened sleeve regions 40 and 41 that lie opposite one another do not have any rough-cast structures.

FIG. 15: A sleeve 37 having a variable sleeve wall thickness, constant depth of the roughened region, and an outer contour consisting of two arc-shaped and two flat segments, in cross-section, which contour is the same as the outer shape of the sleeve 17 shown in FIG. 7, is shown. In this connection, if the sleeve is the first or last element of a sleeve package disposed in a row, a flat segment 43 of the outer contour can be provided with a rough-cast structure, and the segment 42 that lies opposite the former can be configured without a rough-cast structure. In this connection, those segments 38 to 42 of the outer contours of the rough-cast sleeves 35 to 37 that have no rough-cast structures can already be produced within the framework of the casting process. However, it is also possible to provide the entire mantle surface of the sleeve with a rough-cast structure and to subsequently mill away the rough-cast structures of the sleeve regions to be flattened.

The sleeves 17, 31, and 37 shown in FIGS. 7, 11, and 15, the outer contours of which have the flat segments 27, 28, 42, and 43, can be joined to one another by way of these segments, by means of gluing, soldering, or welding, so that sleeve structures that are eyeglass-shaped in cross-section result. This brings with it the advantage that in the production of engine blocks, several sleeves can be placed into the casting machine at the same time, thereby accelerating the production of the engine blocks and making it less expensive. According to FIG. 16, a glue or solder layer 44, in each instance, is applied to the opposite flattened region of the sleeves, in this connection, before the sleeves are joined together.

Another possibility of connecting sleeves with one another before they are cast into an engine block is shown in FIG. 17. In this connection, bridges 45 and 46 are used, which are glued or soldered onto adjacent regions of the faces 47 and 48, i.e. 49 and 50 of the sleeves 51 and 52, respectively, and thereby connect the sleeves 51 and 52.

According to FIG. 18, the bridges 45, 46 can have the shape of round disks. According to FIG. 19, however, the bridges 45′, 46′ can also be given the shape of rectangular slices. The bridges are produced from light metal or from a light metal alloy.

If sleeves are attached to spindle sleeves before being cast, the gap between the sleeves cannot be at just any desired value of narrowness, so that the light metal of the engine block flows through the gap between the sleeves, fills the space between the sleeves, and creates a firm connection between the sleeves after having cooled. If sleeves are flattened on opposite mantle regions, it is necessary, for this purpose, to ensure that the sleeves always assume a clearly defined position of rotation when mounted on the spindle sleeves, so that the gap between the flattened regions of the sleeves maintains its maximal width and is not reduced in size or completely closed off by sleeves that have been partially turned. This can be achieved in that the flattened regions of the sleeve mantle surfaces that lie opposite one another have steps 53, 53′ in their lower regions, facing the crankshaft, which steps are shown in a side view in FIGS. 20, 23, and 24, and in a top view in FIGS. 21 and 22. The steps 53, 53′ also have flattened regions 54, 54′ (FIGS. 20, 23, 24), which must be oriented parallel to one another when the sleeves are pushed onto spindle sleeves, so that the sleeves fit onto the spindle sleeves, and which thereby ensure that the sleeves always assume a clearly defined position of rotation relative to one another. In addition, the sleeves can be joined to one another, i.e. glued or soldered to one another, by way of the flattened regions 54, 54′ of the steps 53, 53′.

Ideally, the width of the gap 55 is 1 mm to 3.5 m in the case of a rough-cast sleeve having a wall thickness 56 of 2.5 mm and a depth 57 of the roughened region of 1.5 mm. The land width 60 is 5.5 mm in the case of sleeves having a cylinder diameter 58 of 82 mm. In this connection, a cylinder distance 59 of 87.5 mm can be achieved.

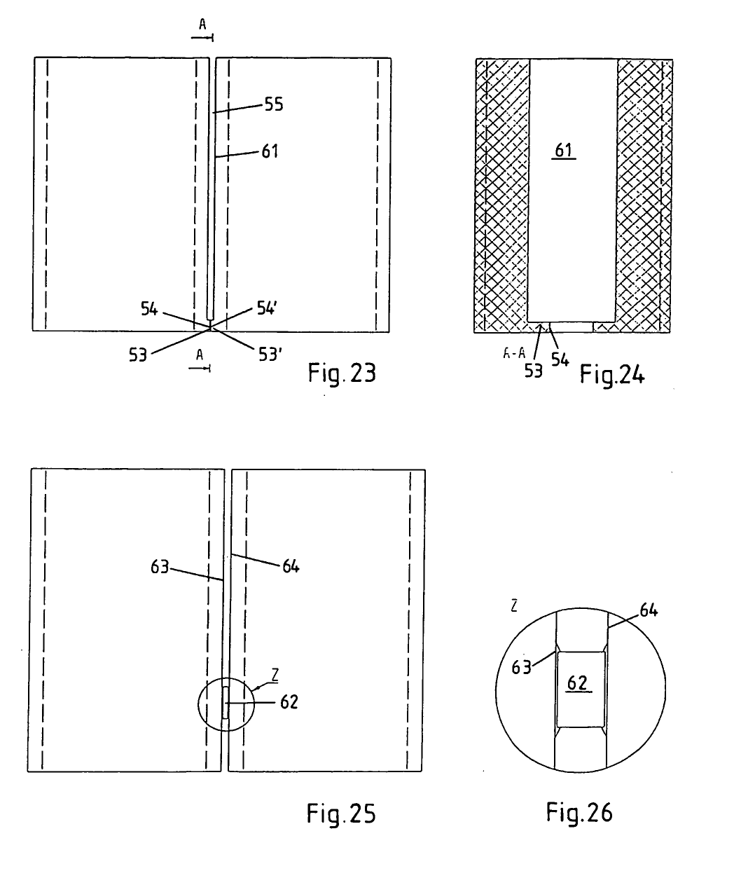

In FIG. 23, the flattened region 61 formed into the sleeve mantle surface can be seen well in a side view, and in FIG. 24, it can be seen well in a top view; in contrast to the remaining sleeve mantle surface, it does not have any roughened region.

Another solution for the problem of keeping the flattened regions of the rough-cast sleeves at a distance and of ensuring that the sleeves are disposed in a clearly defined position of rotation relative to one another consists, according to FIGS. 25 and 26, of a spacer 62 disposed between the flattened regions 63 and 64. This has the additional advantage that space is available between the flattened regions 63 and 64 of the sleeves being held at a distance from one another, for cooling bores to be made in the engine block.

According to a configuration of the rough-cast sleeves not shown in the figures, regions of the outer surfaces of sleeves disposed next to one another, which surfaces lie opposite one another, can be configured in concave manner.

### REFERENCE SYMBOL LIST

x land width
y depth of the roughened region
z distance between two rough-cast sleeves
1 to 4 rough-cast sleeve
5 sleeve package
6 to 8 wall region
9, 10 cross-section
11, 12 elevation
13, 14 undercut
15 to 17 sleeve, cylinder sleeve
18 sleeve package
19, 19′ 19″ sleeve wall
20 roughened region
21 to 24 segment of the outer shape of the sleeve 16
25 to 28 segment of the outer shape of the sleeve 17
29 to 31 sleeve, cylinder sleeve
32 sleeve wall
33, 33′, 33″ roughened region
34 sleeve package
25 to 37 sleeve, cylinder sleeve
28, 39 flattened region of the sleeve 35
40, 41 flattened region of the sleeve 36
42, 43 segment of the outer contour of the sleeve 37
44 adhesive or solder layer
45, 45′, 46, 46′ bridge
47 to 50 face
51, 52 sleeve, cylinder sleeve
53, 53′ step
54, 54′ flattened region of the step 53
55 gap width
56 wall thickness
57 depth of the roughened region
58 cylinder diameter
60 land width
61 flattened region
62 spacer
62, 64 flattened region

1. Cylinder sleeve for an internal combustion engine, the outer surface of which has at least one roughened region (27, 28, 38 to 43, 54, 54′, 61) reaching over its entire axial length, and at least one engagement segment having at least one projection having at least one undercut, at least in its lower region, facing the crankcase, wherein the cylinder sleeve is configured as a rough-cast sleeve, the outer surface of which has a roughened region reaching over its entire axial length and consisting of a plurality of elevations (11, 12) with undercuts (13, 14).

2. Cylinder sleeve according to claim 1, wherein the height of the elevations (11, 12) amounts to 0.2 mm to 2 mm.

3. Cylinder sleeve (15, 29, 35) according to claim 1, comprising an outer contour that is elliptical in cross-section.

4. Cylinder sleeve (16, 30, 36) according to claim 1, comprising an outer contour that consists, in cross-section, of four arc-shaped segments (21 to 24) that are approximately the same size.

5. Cylinder sleeve (17, 31, 37) according to claim 1, comprising an outer contour that consists, in cross-section, of two arc-shaped segments (25, 26) that lie opposite one another, and two flat segments (27, 28) that lie opposite one another.

6. Cylinder sleeve according to claim 3, wherein the outer shape of the cylinder sleeve is formed by means of a sleeve wall thickness that varies over the circumference, at a constant depth of the roughened region.

7. Cylinder sleeve according to claim 3, wherein the outer shape of the cylinder sleeve is formed by a depth of the roughened region that varies over the circumference, at a constant sleeve wall thickness.

8. Cylinder sleeve according to claim 1, wherein the at least one flattened region is provided with a step (53) having a flattened region (54) lying radially on the outside, on its lower side facing the crankcase.

9. Cylinder sleeve according to claim 1, wherein it consists of cast iron and is produced using the spin casting method.

10. Cylinder sleeve according to claim 1, wherein it consists of an aluminum-silicon alloy.

11. Cylinder sleeve according to claim 10, wherein it is produced using the gravity casting method.

12. Cylinder sleeve according to claim 10, wherein it is produced using the spin casting method.

13. Cylinder sleeve according to claim 10, wherein it is produced using the lost-foam casting method.

14. Cylinder sleeve according to claim 1, wherein it consists of a sintered metal.
